(19) United States
(12) Patent Application Publication
(10) Pub. No.: US 2007/0001827 A1
(43) Pub. Date: Jan. 4, 2007

(54) Remote asset management of computer systems

(75) Inventors: Steven W. S. Asbjornsen, Tualatin, OR (US); Hong W. Wong, Portland, OR (US)

Correspondence Address: INTEL CORPORATION, P.O. BOX 5326, SANTA CLARA, CA, 95056-5326, US

(73) Assignee: Intel Corporation

(21) Appl. No.: 11/174,153

(22) Filed: Jun. 30, 2005

(51) Int. Cl. B60R 25/10

(52) U.S. Cl. 340/426.13

(57) ABSTRACT

A security device that is configured to receive lock and unlock signals from a remote location via a communication channel. The security device may include a sensor to detect unauthorized disablement and may generate warning signals to report such unauthorized disablement.

### FIELD OF INVENTION

The present invention relates generally to the field of asset management; and, more specifically, to a technique for remotely managing computer systems.

### BACKGROUND

Typically, mobile systems such as lap top computer systems are used because they are thin, light and thus easily transportable. Due to many factors including battery life and heat generation, the mobile systems generally tend to be not as powerful as their desktop counterparts. However, with advanced developments in power management and thermal management, the mobile systems today are capable of performing as well as the traditional desktop systems.

The traditional desktop systems tend to be bulky and heavy, thus not easily transportable. They, however, may still be susceptible to theft or unauthorized move. To prevent this from happening, a desktop system may be attached to a security device to secure it to, for example, a desk. A user of the desktop system may be provided a key to lock or to unlock the security device. Because of the advantages of the mobile systems, companies are increasingly using the mobile systems as both desktop systems and traveling systems. It is possible that when the mobile systems are used as the desktop systems, the users of these mobile systems may leave them on their desks until when it is necessary to move them. Because the mobile systems are light and thin, they may be even more susceptible to theft or unauthorized movement than the traditional desktop systems. The same security techniques used to protect the traditional desktop systems may be used to protect the mobile systems. In certain situations, these techniques may not be efficient and improved techniques may be necessary.

### BRIEF DESCRIPTION OF THE DRAWINGS

The present invention is illustrated by way of example and not limitation in the accompanying figures in which like references indicate similar elements and in which:

FIG. 1 illustrates an example of a computer system, in accordance with one embodiment.

FIG. 2 illustrates an example of a computer system with its security device, in accordance with one embodiment.

FIG. 3 is a block diagram illustrating one example of a process that may be followed to unlock a security device to transport a computer system.

FIGS. 4A, 4B, and 4C are block diagrams illustrating examples of an improved security device, in accordance with one embodiment.

FIG. 5 is a block diagram illustrating one implementation example of an improved security device, in accordance with one embodiment.

FIG. 6 is a flow diagram illustrating one example of a process that may be followed when using the improved security device, in accordance with one embodiment.

FIG. 7 is a block diagram illustrating another implementation example of an improved security device, in accordance with one embodiment.

FIG. 8 is a block diagram illustrating another implementation example of an improved security device, in accordance with one embodiment.

FIG. 9 is a block diagram illustrating one example of a process that may be performed to detect unauthorized break in a security cable, in accordance with one embodiment.

### DETAILED DESCRIPTION

In some embodiments, a computer system may include security logic that is capable of sending signals to control operation of a security device including causing the security device to lock or to unlock. The security logic may be controlled remotely via a communication line.

In the following description, for purposes of explanation, numerous specific details are set forth to provide a thorough understanding of the present invention. It will be evident, however, to one skilled in the art that the present invention may be practiced without these specific details. In other instances, well known structures, processes, and devices are shown in block diagram form or are referred to in a summary manner in order to provide an explanation without undue detail.

Computer System

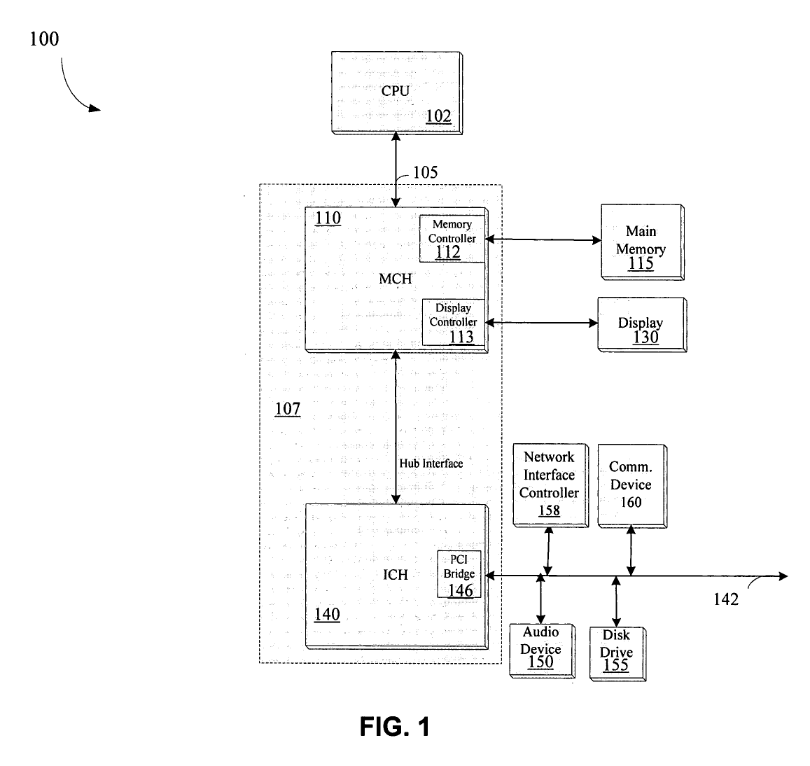

FIG. 1 illustrates an example of a computer system, in accordance with one embodiment. Computer system 100 may include a central processing unit (CPU) or processor 102 and may receive its power from an electrical outlet or a battery. The CPU 102 may be coupled to a bus 105. Chipset 107 may be coupled to the bus 105. The chipset 107 may include a memory control hub (MCH) 110. The MCH 110 may include a memory controller 112 that is coupled to system memory 115. The system memory 115 may store data and sequences of instructions that are executed by the CPU 102 or any other processing devices included in the computer system 100. The MCH 110 may include a display controller 113. A display 130 may be coupled to the display controller 113.

The chipset 107 may also include an input/output control hub (ICH) 140. The ICH 140 is coupled with the MCH 110 via a hub interface. The ICH 140 provides an interface to input/output (I/O) devices within the computer system 100. The ICH 140 may be coupled to a peripheral bus (e.g., Peripheral Component Interconnect (PCI) bus) 142. The ICH 140 may include a PCI bridge 146 that provides an interface to the PCI bus 142. The PCI bridge 146 may provide a data path between the CPU 102 and peripheral devices. The ICH 140 may be connected to a network interface controller (NIC) 158 via the PCI bus 142. A communication device 160 may be connected to the PCI bus 142. The PCI bus 142 may also be connected to various I/O devices such as, for example, audio device 150, storage device 155, etc. The computer system 100 may be connected to another computer system using the communication device 160.

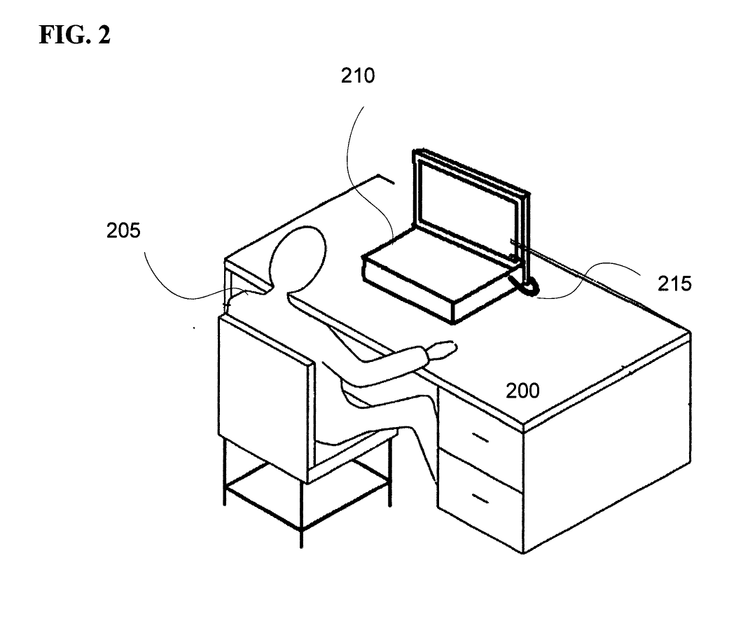

FIG. 2 illustrates an example of a computer system with its security device, in accordance with one embodiment. Computer system 210 may be a mobile computer system that can also be used as a desktop system. When the computer system 210 is deployed in a corporate environment, it may be registered with an information technology (IT) department before being distributed to user 205. The registration information may include information about the user 205, work desk location where the computer system 210 is to be located when it is not used by the user 205 away from the work desk, unique identification of the computer system 210, etc. The unique identification may be used by the IT department to identify the computer system 210 via, for example, a network connection.

The user 205 may also be provided with a security device 215 and a key (not shown). The computer system 210 is illustrated in this example as being secured to desk 200 using the security device 215. Typically, the security device 215 is a mechanical device and may include a key lock and a security cable connected to the computer system 210 via a security slot. For example, the security device 215 may be one that is manufactured by Kensington Technology Group of ACCO Brands, Inc. of Lincolnshire, Ill. It is not uncommon for the user 205 to misplace or lose the key. When this occurs, the computer system 210 may not be transported until a duplicate key can be delivered or until the security cable can be cut. There may be a delay associated with this approach because the user 205 may have to wait for a support personnel to arrive. Furthermore, there may be situations when the computer system 210 may need to be transported into the IT department for, for example, periodic upgrades. Such authorized transport may not be possible when the computer system 210 is located at the work desk and the user 205 is not present to provide the key.

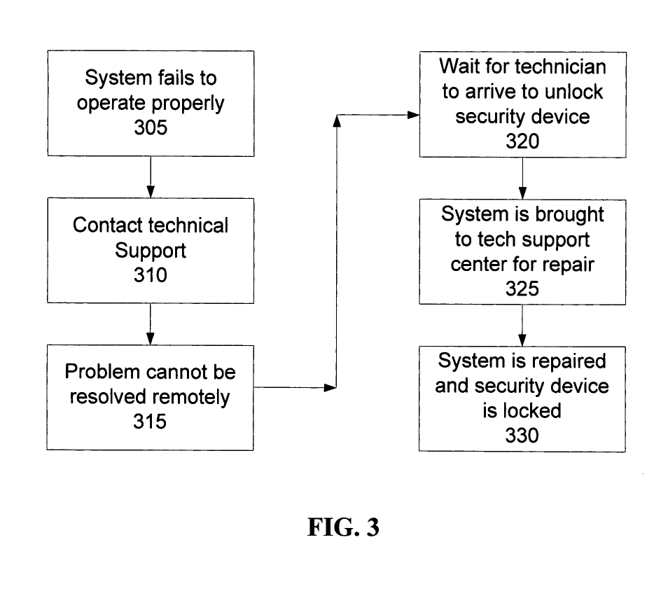

FIG. 3 is a block diagram illustrating one example of a process that may be followed to unlock a security device to transport a computer system. For this example, the transporting of the computer system is for the purpose of performing operations (repair, updates, replacement, etc.) that may not be performed locally at the work desk. At block 305, the user 205 recognizes that the computer system 210 is experiencing some problems. The user 205 may contact the IT department to assist with correcting the problems, as shown in block 310. After spending a certain length of time on the phone with the user 205, the technician at the IT department may determine that the problems cannot be resolved over the phone (as shown in block 315), and that the computer system 200 may need to be brought into the IT department. In this example, the user 205 is not able to unlock the security device 215 due to, for example, misplacement of the key. As such, the user 205 cannot personally transport the computer system 200 to the IT department. Instead, the user 205 may need to wait for a technician to arrive and to disable the security device 215, as shown in block 320. For example, the technician may be equipped with a master key to enable him/her to open the security device 215. This wait may be for a considerable length of time during which the user 205 may not be able to perform work, access emails, etc.

After the security device is disabled or unlocked by the technician, the computer system 200 may be brought to the IT department to do the repair/updates, etc. (as shown in block 325). Subsequently, the computer system 200 (or its replacement) may be returned to the user 205 and re-secured using the security device 215, as shown in block 330. It may be noted that the time waiting for the technician to arrive may be avoided if the security device 215 can be unlocked on behalf of the user 205 remotely. It may also be noted the disablement of the security device 215 may be unauthorized (i.e., theft), and confidential data stored in the computer system 200 may be at risk. In these situations, it may be necessary to disable the computer system 200 to deter theft and to protect the confidential data.

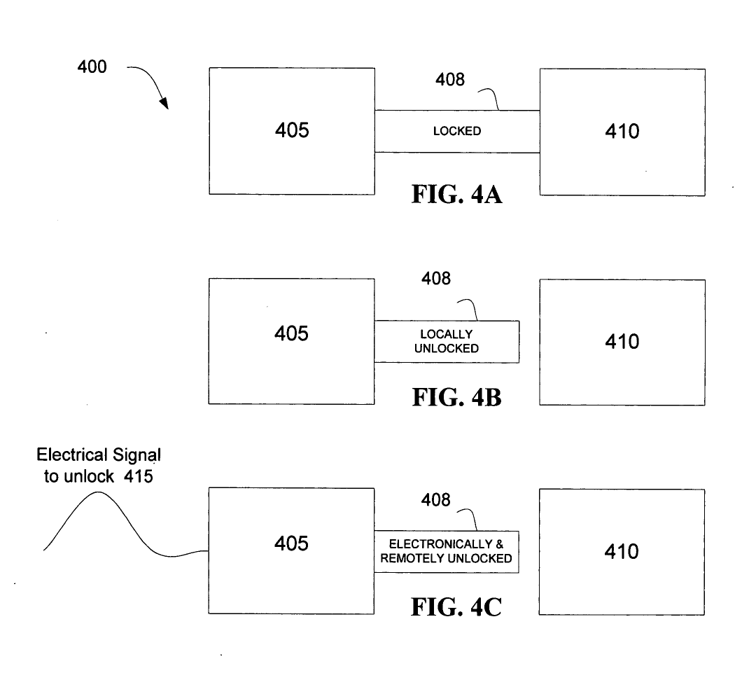

FIGS. 4A, 4B, and 4C are block diagrams illustrating examples of an improved security device, in accordance with one embodiment. In this example, security device 400 may include blocks 405 and 410 and connector 408 (e.g., cable). When the security device 400 is locked, the connector 408 connects the block 405 to the block 410, as illustrated in FIG. 4A. For one embodiment, the security device 400 may be unlocked locally using a key (not shown) causing the connector 408 to be detached from the block 410, as illustrated in FIG. 4B. For another embodiment, the security device 400 may include logic that enable it to receive signals 415 from a remote location causing the security device 400 to unlock, as illustrated in FIG. 4C.

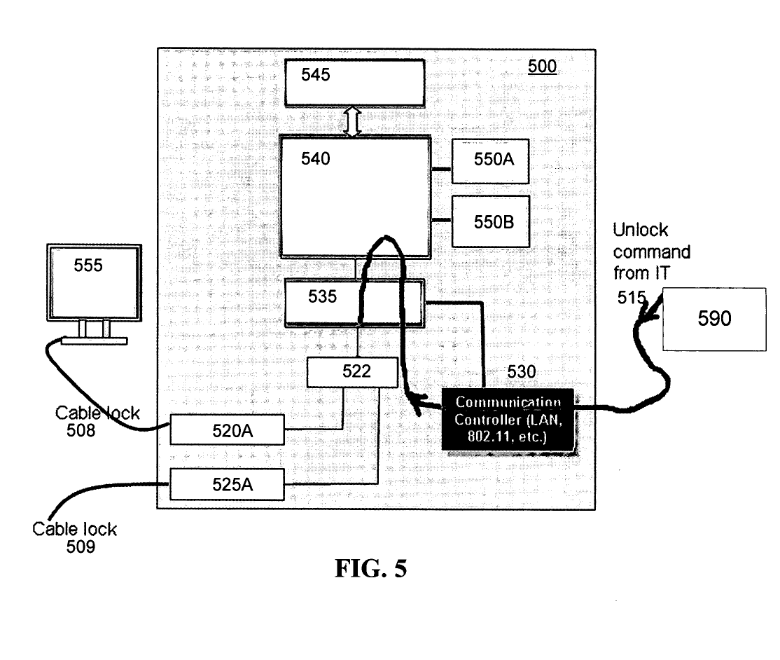

FIG. 5 is a block diagram illustrating one implementation example of an improved security device, in accordance with one embodiment. In this example, computer system 500 may include processor 545, MCH 540 and ICH 535. The MCH 540 may be coupled to memory devices 550A, 550B. The ICH 535 may be coupled to communication controller 530. For one embodiment, the communication controller 530 may be configured to receive a signal (e.g., lock or unlock signal) 515 from computer system 590. The computer system 590 may be located in a remote location, and the signal 515 may be received via a wired or a wireless connection. For example, the computer system 590 may be a computer system from the IT department, and the signal 515 may be generated when a lock or unlock command is issued by a technician from the computer system 590.

The signal 515 may be examined by logic 522 to determine whether it is for the security device 520A, 525A or both. The logic 522 may be a super input/output (I/O) chip. For one embodiment, the signal 515 may be generated to control the security device 520A or the security device 525A or both. This may be applicable when the display 555 and the computer system 500 are two separate units. It may be possible that there is only one security device (e.g., device 509) when the computer system 500 includes an integrated display (e.g., a lap top with a clam shell form factor or the like). In the current example, the security devices 520A and 525A are coupled to the ICH 525. For one embodiment, the security devices 520A and 525A may be considered to be output devices, and the signal 515 is sent from the ICH 535 as an output signal to be processed by the security devices 520A, 525A or both. Some levels of authorization verification may need to be performed before the signal 515 is sent. The security devices 520A and 525A may be integrated into the computer system 500. For one embodiment, a security device may store information about its current status. For example, upon receiving a status request signal, the security device may respond with a positive signal (operational, locked) or negative signal (not operational, disabled, and unlocked).

It may be noted that the security devices 520A and 525A may be unlocked locally though the use of a mechanical or electronic key. The electronic key may be entered using a keypad (not shown) on the security device 520A or 525A. Alternatively, the electronic key may be activated when an unlock signal is sent from the computer system 590.

For one embodiment, the computer system 500 may include an out-of-band controller (not shown). The OOB controller may be coupled to a power source enabling it to remain active even when the computer system 500 is powered off. This power source may be the same power source as used by the computer system 500. Alternatively, this may be a separate power source. The power source used by the OOB controller may be a direct current (DC) power source. The OOB controller may be part of the communication controller 530, or it may be part of a chipset (e.g., ICH 535 and MCH 540). The OOB controller may serve to receive in-coming lock and unlock signals from the computer system 590. As will be described, the OOB controller may also serve to send warning signals to the computer system 590. Having the OOB controller may be advantageous because it enables an independent communication channel between the computer system 590 and the security devices 520A and 525A.

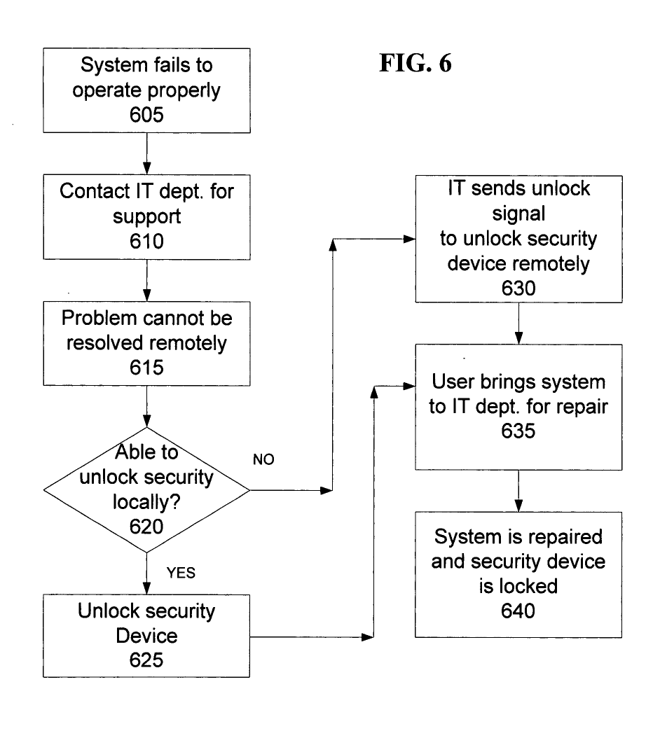

FIG. 6 is a flow diagram illustrating one example of a process that may be followed when using the improved security device, in accordance with one embodiment. In this example, an electronic security device may be used to secure a computer system and may operate with an electronic lock or unlock signal. As shown in block 605, a locked computer system fails to operate properly. The IT department is contacted, as shown in block 610. At block 615, it is determined that the problem can not be resolved by the technical support over the phone, and the computer system may need to be brought into the IT support center so that the problem can be analyzed. At block 620, if the security device can be unlocked by the user, it may be unlocked and brought into the IT support center, as shown in block 635. This operation may be desirable because it may minimize any potential delay in getting the problem taken care of. However, at block 615, if the user is unable to unlock the security device, instead of waiting for a technician to arrive, an electronic unlock command may be issued by a technician at the IT support center to unlock the security device, as shown in block 630. The process then continues at block 635. At block 640, the computer system is repaired or replaced and returned to the user desk where it is secured with the security device.

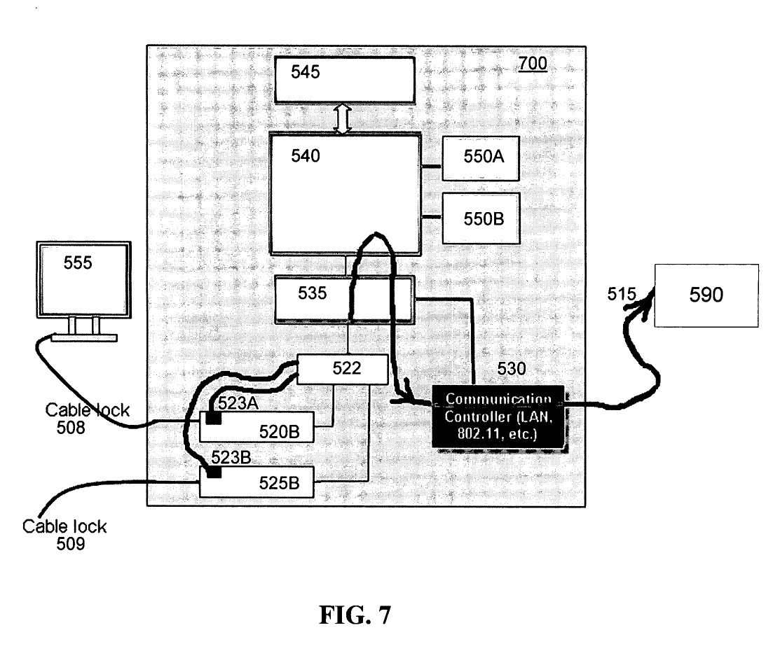

FIG. 7 is a block diagram illustrating another implementation example of an improved security device, in accordance with one embodiment. In this example, computer system 700 may be similar to the computer system 500 illustrated in FIG. 5, except that the security device 520B and 525B. In the following example, the unlocking of a security device is considered to be authorized when the security device is unlocked by receiving an unlock signal or by using a mechanical or electronic key. Any other operations to disable the security device directly or indirectly may be considered to be unauthorized unlocking of the security device.

For one embodiment, a security device may include logic to enable it to send signals. For example, the security device 520B and 525B may be viewed as input devices and signals sent by them may be received by the ICH 535. For one embodiment, a security device may send warning signals when it senses a break in the cable/connector. A sensor may be integrated onto the security device to sense the presence or the cut of the cable. The sensor may be a capacitance sensor to detect the change of the capacitance of the cable. A cut or the removal of the cable may change the capacitance detected and a warning signal may be generated to indicate such tempering event. For example, when someone cuts off the cable 509, security sensor 523B in the security device 525B may send a warning signal to the logic 522. Security sensor 523A may also send warning signals to the logic 522 in similar situation. The logic 522 may then cause a warning signal in the form of an interrupt to be generated. Upon receiving the interrupt, the processor 545 may cause a warning signal to be sent to the computer system 590 via the communication controller 530. Upon receiving the warning signal from the computer system 700, the IT department may verify with the owner of the computer system 700 to determine if the warning is legitimate and the break in the cable is unauthorized. For one embodiment, when the warning signal is legitimate, the IT department may be send signal to disable operation of the computer system 700. For example, using wireless communications, the IT department may cause the computer system 700 to fail to start during power on reset.

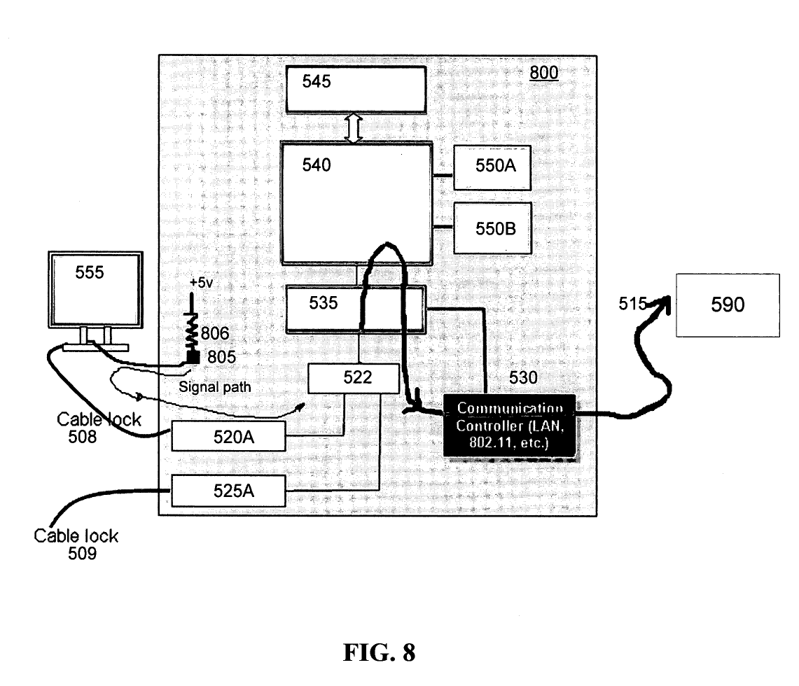

FIG. 8 is a block diagram illustrating another implementation example of an improved security device, in accordance with one embodiment. In this example, computer system 800 may be similar to the computer system 700 illustrated in FIG. 7, except that the end of the cable 508 is looped back and attached to the chassis of the computer system 800. Referring to the example in FIG. 8, one end of the cable 508 is connected to a pull-up resistor 806 such that the cable 508 is pulled up with a positive voltage (+5V). The other end of the cable 508 is connected to the security device 520A. This end of the cable 520A may also act as the input to the logic 522. When the cable 508 is cut, or when it is forcedly removed from the security device 520A, the signal to the logic 522 may toggle from high to low and triggers an interrupt. The processor 545 then recognizes that the cable 508 or the security device 520A is being tempered and a warning signal may then be sent to the IT department at the computer system 590. Appropriate disablement actions may be performed by the IT department.

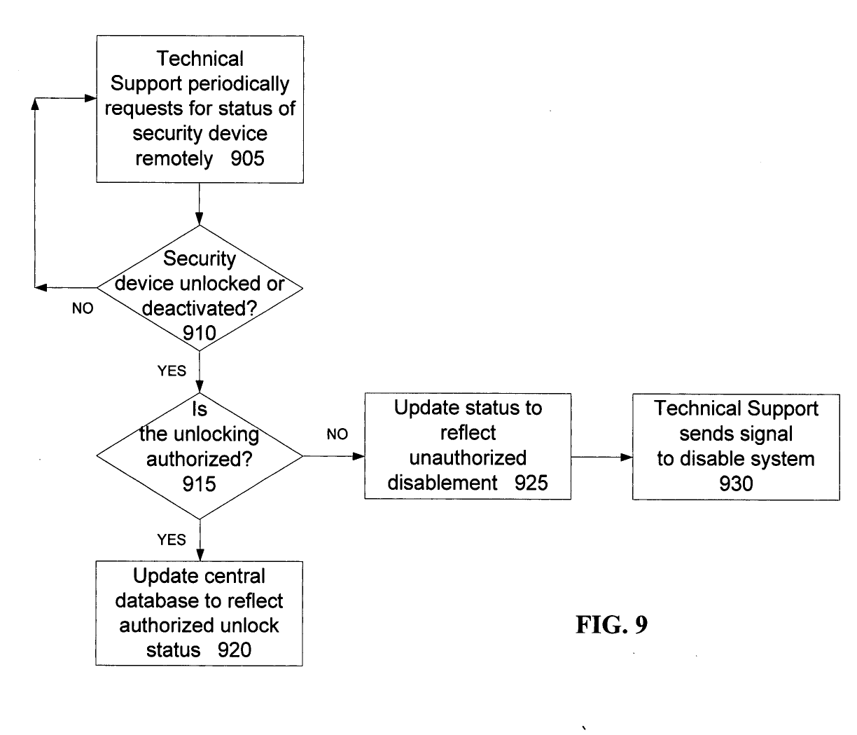

FIG. 9 is a block diagram illustrating one example of a process that may be performed to detect unauthorized break in a security cable, in accordance with one embodiment. The process may be an active monitoring process by using periodic polling. Alternatively, the process may be passive by waiting for a warning signal to be received. At block 905, polling signals are periodically generated to poll the status of the status of the security device. At block 910, a test may be performed to determine if the security device is disabled. If it is not disabled, the process flows back to block 905. If it is disabled, then another test may be performed to determine if the disablement is authorized, as shown in block 915. If it is unauthorized, the process flows to block 925 where the status of the security device is updated as unauthorized disablement. At block 930, appropriate actions may be performed to disable the computer system associated with the disabled security device. From block 915, if the disablement is authorized, the process flows to block 920 where the status of the security device is updated as authorized disablement.

In some embodiments, it is to be understood that they may be implemented as one or more software programs stored within a machine readable medium. A machine readable medium includes any mechanism for storing or transmitting information in a form readable by a machine (e.g., a computer). For example, a machine readable medium includes read only memory (ROM), random access memory (RAM), magnetic disk storage media, optical storage media, flash memory devices, electrical, optical, acoustical or other form of propagated signals (e.g., carrier waves, infrared signals, digital signals, etc.), etc.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method, comprising:
receiving a request to unlock a security device used to secure a first computer system; and
sending an unlock signal to unlock the security device, wherein the security device is configured to be unlocked using either the unlock signal or using a key.

2. The method of claim 1, wherein the key is a manual key or an electronic key.

3. The method of claim 2, wherein the unlock signal is sent from a second computer system using wired or wireless communications.

4. The method of claim 3, wherein the unlock signal is processed using an out-of-band (OOB) controller in the first computer system.

5. The method of claim 3, wherein the request to unlock is verified before the unlock signal is sent.

6. A method, comprising:
sensing a break associated with a locked security device used to secure a first computer system, the break causing the first computer system to be unsecured;
from the first computer system, sending a first signal to a second computer system to indicate the break;
when the break is determined to be unauthorized, from the second computer system, sending a second signal to the first computer system to disable the first computer system.

7. The method of claim 6, wherein disabling the first computer system comprises causing the first computer system to fail to boot.

8. The method of claim 6, wherein the first signal and the second signal are processed by an out-of-band (OOB) controller in the first computer system.

9. The method of claim 6, wherein the break is sensed when the security device is disabled without using a key.

10. The method of claim 9, wherein the key is a mechanical key or an electronic key

11. The method of claim 10, wherein the electronic key is activated when the second computer system sends an unlock signal to the first computer system to unlock the security device.

12. The method of claim 9, wherein the security device is disabled when a cable coupled to the security device is disconnected.

13. An apparatus, comprising:
logic to receive an unlock signal to unlock a security device, the unlock signal received via a communication channel, the security device used to secure a first computer system; and
logic to send a warning signal to a second computer system via the communication channel when the security device is disabled without authorization.

14. The apparatus of claim 13, wherein the unlock signal is to cause a cable coupled to the security device to be disconnected from the security device.

15. The apparatus of claim 14, wherein the warning signal is sent when the cable is disconnected from the security device without authorization.

16. The apparatus of claim 15, wherein the warning signal is sent when there is a break in the cable.

17. The apparatus of claim 16, wherein responsive to receiving the warning signal, the second computer system is to send disable signal to the first computer system to disable the first computer system.

18. A system, comprising:
a communication controller to receive lock or unlock signal to control operation of a security device, wherein the lock or unlock signal are sent by a networked computer system; and
a sensor to sense a break in a cable coupled to the security device.

19. The system of claim 18, wherein when the break in the cable is determined to be unauthorized, the communication controller is to send a warning signal to the networked computer system.

20. The system of claim 18, wherein the communication controller is an out-of-band (OOB) controller.
